(19) United States
(12) Patent Application Publication
(10) Pub. No.: US 2006/0272348 A1
(43) Pub. Date: Dec. 7, 2006

(54) Iced beverage dispensing tower

(76) Inventors: Melvin D. Kyees, Yorba Linda, CA (US); Richard O. Kyees, Yorba Linda, CA (US)

Correspondence Address: BRINKS HOFER GILSON & LIONE, P.O. BOX 10395, CHICAGO, IL, 60610, US

(21) Appl. No.: 11/437,835

(22) Filed: May 19, 2006

Related U.S. Application Data
(60) Provisional application No. 60/683,396, filed on May 20, 2005.

(51) Int. Cl. B67D 5/62

(52) U.S. Cl. 62/390; 62/389

(57) ABSTRACT

A beverage dispensing tower includes an exterior surface; at least one beverage dispensing tap and a beverage supply line connected thereto; and a coolant flow path in sufficient thermal contact with the exterior surface so that as coolant flows through the flow path, at least part of the exterior surface can be cooled to a temperature below 32° F. when the dispensing tower is in contact with air having and ambient temperature of 68° F., the coolant flow path not being in direct contact with the beverage supply line.

### RELATED APPLICATION

The present application claims the benefit under 35 U.S.C. § 119(e) of Provisional U.S. Patent Application Ser. No. 60/683,396, filed May 20, 2005; which is hereby incorporated by reference in its entirety.

### BACKGROUND OF THE INVENTION

The present invention relates to beverage dispensing equipment, and particularly to a beverage dispensing tower which may become iced-over when in use.

Beverage dispensing equipment often fulfills not only a functional role, but an aesthetic role as well. In an establishment where beverages are served, the beverage dispensing equipment is often in an area where members of the public see the dispensing equipment. One particular type of beverage dispensing equipment that fits into this category is beverage dispensing towers. Beer dispensing towers are a good example. Such towers are often located on a countertop, such as a bar. Owners of the establishment wish to present a pleasing aesthetic appearance to members of the public that come into the establishment. Therefore it is desirable that the beverage dispensing towers have pleasing look.

One such beverage dispensing tower is referred to as a “cobra tower”. Other beverage dispensing towers in this category include “draught arms” and “T-towers.”

Because the beverages served from these towers are usually consumed cold, the towers must be conducive to chilling the beverage, or at least keeping it cold, while it is being dispensed. Often the beverage is also cooled while it is transported from a storage area to the serving area. A cooling line recirculating a coolant is often included in a “trunk tube” that encompasses the beverage supply lines running from a back room to the bar. One particularly effective way to chill beer before dispensing it through a dispensing tower is to use a cold plate such as disclosed in U.S. Pat. No. 6,487,873. The cold plate includes beverage lines and coolant lines inside of a cast aluminum plate. Chilled glycol is circulated through the cold plate, and the beer is conveyed through the beverage lines in the cold plate from the beer supply source on its way to the dispensing tower. The '873 patent discloses cold plates that are shaped such that they can include a tower portion, or be built into a beverage dispensing tower.

One innovation applied to the cobra tower was to connect the recirculating coolant line to the tower itself in such a way that the coolant flooded the hollow area inside of the cobra tower. This produced a dramatic effect, in that the housing of the cobra tower was chilled to the point where humidity in the air would accumulate on the tower, causing it to become iced over. Several things had to be taken into consideration in making such a flooded tower. First, the tower had to be sealed, since the coolant is fed into the housing by one tube, floods the housing, and then is withdrawn through a second tube. Second, the beverage dispensing line also runs through the housing, and was thus also contacted by the coolant. The beverage, being predominantly water, had a tendency to freeze and plug up the beverage supply line when no beverage was being dispensed. As a result, a fairly thick-walled beverage supply line has to be used in a flooded cobra tower to prevent the beer inside the line from freezing. It is believed that this same technique may be used in another tower sold by Universal Dispensing Systems of the U.K. as the Moderna Artic Font.

The iced-over cobra tower has been in use for many years, and has a certain appeal. Many patrons are drawn to the iced-over tower when they enter an establishment where it is in use. The iced-over nature helps to convey the idea that beverages dispensed by the iced-over cobra tower will be ice-cold. However, other types of beverage dispensing towers have not hitherto been configured so that they could be iced-over. For whatever reason, the difficulties encountered in making the cobra tower so that it could be iced over, and still function as a beverage dispensing tower, and the cost involved, have, up until the present invention, limited the known iced-over beverage dispensing towers to the flooded cobra tower and the like.

### SUMMARY OF THE INVENTION

Other iced beverage towers have now been invented. New ways of making the tower so that it can be cooled to the point of being iced-over make it possible to have iced over draught arms and iced over T-towers, as well as other tower shapes. The preferred embodiments of the invention make these towers economical.

In a first aspect, the invention is a beverage dispensing tower that includes a visible exterior surface; at least one beverage dispensing tap and a beverage supply line connected thereto; and a coolant flow path in sufficient thermal contact with the exterior surface so that as coolant flows through the flow path, at least part of the exterior surface can be cooled to a temperature below 32° F. when the dispensing tower is in contact with air having and ambient temperature of 68° F., the coolant flow path not being in direct contact with the beverage supply line.

In a second aspect, the invention is a an iced-over beverage dispensing tower comprising a housing having a cylindrical base; at least one beverage dispensing tap mounted on the housing and a beverage supply line connected thereto inside the housing; and a coolant in sufficient thermal contact with the housing to cool a majority of the housing to a temperature below 32° F. when the housing is in air with an ambient temperature of 68° F.

In a third aspect, the invention is a beverage serving system comprising a countertop having a drain surface; and a beverage dispensing tower upstanding from the countertop, the beverage dispensing tower comprising a housing having a visible exterior surface; at least one beverage dispensing tap mounted on the housing and a beverage supply line connected thereto inside the housing, the dispensing tap being located above the drain surface; and at least one confined cooling channel inside the housing in sufficient thermal contact with the housing so that when a coolant flows through the channel, at least a majority of the exterior surface of the housing can be cooled to a temperature below 32° F. when the exterior surface is in contact with air having an ambient temperature of 68° F.

In a fourth aspect, the invention is a beverage dispensing system comprising a beverage dispensing tower comprising a housing and having at least one beverage dispensing tap mounted on the housing; a beverage supply connected to the beverage dispensing tap by a beverage line; and at least one confined cooling channel inside the housing in sufficient thermal contact with the housing so that when a coolant flows through the channel, at least a majority of the housing can be cooled to a temperature below 32° F. when the housing is in contact with air having an ambient temperature of 68° F.

In a fifth aspect, the invention is a beverage dispensing tower comprising a housing; at least one beverage dispensing tap mounted on the housing and a beverage supply line connected inside the housing to the tap; and at least one confined cooling channel inside the housing in sufficient thermal contact with the housing so that when a coolant flows through the channel, at least a majority of the housing can be cooled to a temperature below 32° F. when the housing is in contact with air having an ambient temperature of 68° F.

The present invention provides iced over beverage dispensing towers of different shapes, such as the draught arm and T-tower. Using the present invention, other novel shaped beverage dispensing towers may be iced over. In the preferred embodiments, using a confined cooling channel rather than flooding the entire inside of the housing, the housing does not have to be sealed where the beverage line enters the housing. These and other advantages of the invention will be best understood in view of the attached drawings, a brief description of which follows.

### BRIEF DESCRIPTION OF THE DRAWINGS

FIG. 1 is a perspective view of a beverage dispensing tower of a first embodiment of the invention.

FIG. 2 is a partially exploded and partial cross-sectional view of the beverage dispensing tower of FIG. 1.

FIG. 3 is a cross sectional view takes along line 3-3 of FIG. 1.

FIG. 4 is perspective view of a beverage dispensing tower of a second embodiment of the invention.

FIG. 5 is a partial cross-sectional view of the beverage dispensing tower of FIG. 4.

FIG. 6 is perspective, partial cross-sectional, view of a beverage dispensing tower of a third embodiment of the invention.

FIG. 7 is a schematic view of a casting used to make the beverage dispensing tower of FIG. 6.

FIG. 8 is a schematic view of a drilled block that could be used as an alternate way of making the beverage dispensing tower of FIG. 6.

FIG. 9 is a partially exploded and partial cross-sectional view of another embodiment of a beverage dispensing tower.

FIG. 10 is a cross sectional view takes along line 10-10 of FIG. 9, showing the device iced over.

FIG. 11 is an exploded view of parts of the tower of FIG. 9.

FIG. 12 is perspective view of a beverage dispensing tower of another embodiment of the invention.

FIG. 13 is perspective view of a beverage dispensing tower of yet another embodiment of the invention.

FIG. 14 is rear perspective, partially broken away view of another beverage dispensing tower of the invention.

FIG. 15 is a front perspective with partial sectional view of the tower of FIG. 14.

### DETAILED DESCRIPTION OF THE DRAWINGS AND PREFERRED EMBODIMENTS OF THE INVENTION

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

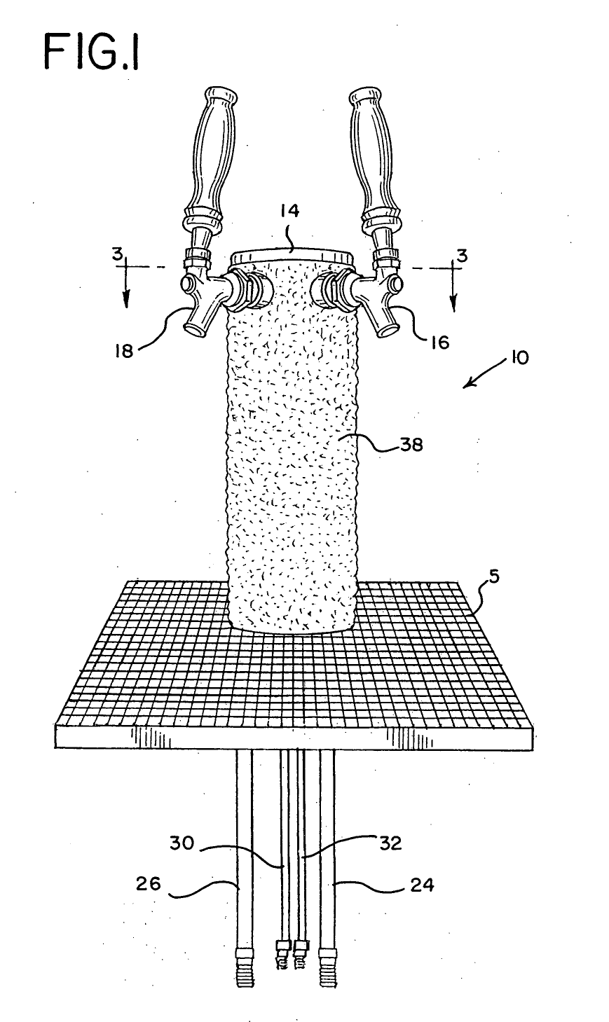

A first embodiment of an iced beverage dispensing tower 10 of the present invention is shown in FIGS. 1-3. The tower 10 is shown as part of a beverage serving system that also includes a countertop having a drain surface 5. The beverage dispensing tower is upstanding from the countertop. This of course is part of a beverage dispensing system, which includes not only the beverage dispensing tower but a beverage supply connected to the beverage serving system by a beverage line. For a complete description of the remainder of a typical beverage dispensing system, attention is drawn to U.S. Pat. No. 6,487,873, which is incorporated herein by reference.

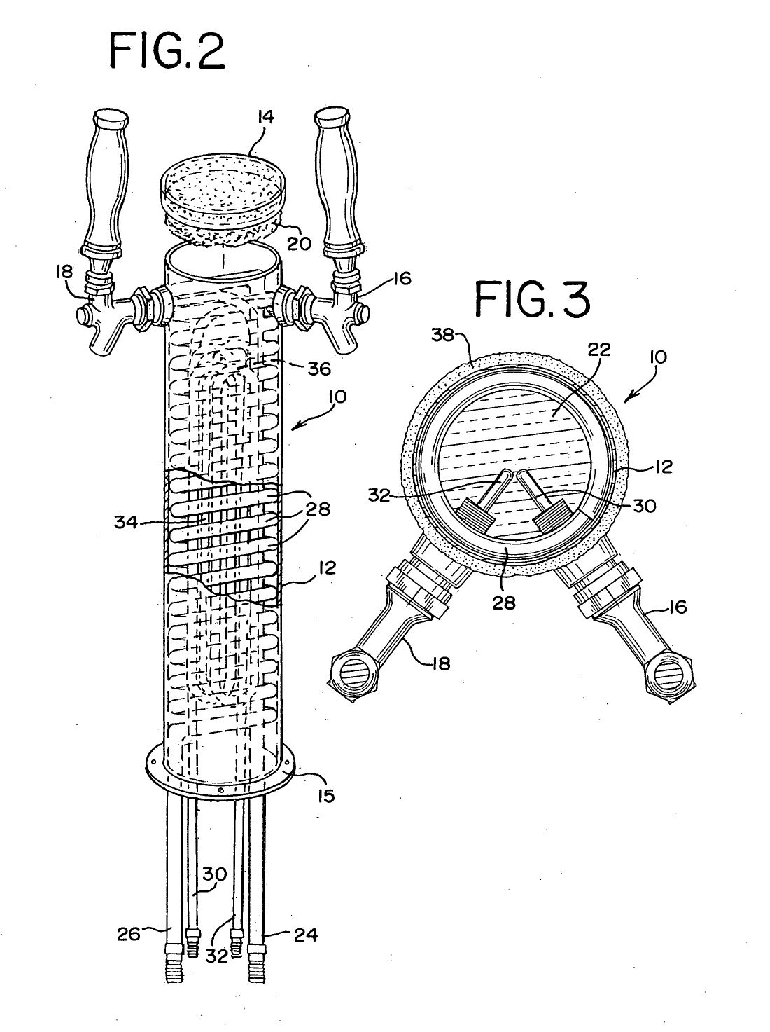

In FIGS. 1 and 3, the tower 10 is shown as an iced-over beverage dispensing tower. FIG. 2 shows the components of the tower 10 without any frost icing over the tower. The beverage dispensing tower 10 has a housing 12 comprising a cylindrical base and two beverage dispensing taps 16 and 18 mounted on the housing 12. In this embodiment, the housing comprises a single structure. The dispensing taps are located above the drain surface 5. The housing 12 further includes a cap 14. A flange 15 on the bottom of the housing is configured to secure the housing to a top surface of a counter. Beverage supply lines 30 and 32 are connected respectively to taps 16 and 18 inside the housing 12 and run down through a hole in the counter to connect with the rest of the beverage dispensing system. In one preferred embodiment, each beverage supply line 30 and 32 supplies beer to the dispensing taps 16 and 18. In that case, the beverage supply lines preferably each include at least one, and preferably two, coils 34, with bends 36 at the ends, inside the housing. These coils 34 provide the beer lines with a reduced diameter restrictor line, as explained in U.S. Pat. No. 6,487,873.

The tower 10 includes a coolant flow path in sufficient thermal contact with the exterior surface of the housing to cool a majority of the exterior surface to the point where frost will form on the outside of the housing. In the embodiment depicted, the coolant is inside of a cooling coil in thermal contact with the housing. Thus, the tower includes at least one confined cooling channel inside the housing 12. The coolant flow path is not in direct contact with the beverage supply lines. In the embodiment of FIGS. 1-3, the at least one confined cooling channel comprises tubing. The tubing includes an inlet 24, an outlet 26 and a plurality of tubing turns 28 arranged in a helical fashion inside the housing 12. The confined cooling channel carries a liquid coolant, such as glycol. The cooling channel is in sufficient thermal contact with the housing so that when a coolant flows through the channel, at least a majority of the housing can be cooled to a temperature below 32° F. when the housing is in contact with air having an ambient temperature of 68° F., thus producing a layer of frost 38 on the outside of the housing. This may be accomplished by including a heat conductive epoxy between the cooling coils 28 and the inside surface of housing 12. Since the coils 28 are in a helical form, it is also possible to form the coils with a slightly greater outside diameter than the inside diameter of the housing 12. The coils would then be twisted like a spring to decrease their diameter, inserted into the housing, and then released. The coils would then try to spring back to their original dimension, and form a tight fit against the inside wall of the housing. This tight fit may be sufficient to create the required thermal contact between the housing and the coolant tubing. Tubing with a cross-section having at least one flat side, such as square cross-section tubing, may also be advantageously used to create greater thermal conductivity by having the flat surface on the outside of the coil.

To prevent the beverage lines 30 and 32 from becoming too cold and possibly causing the beverage to freeze, it is preferred that insulation, such as a solid insulation in the form of insulating foam 22 be placed in the housing between the confined cooling channel and the beverage supply lines. Also, it may be preferable that the cap 14 not get frosted over when the rest of the housing 12 ices over. In that case, the cap 14 may be insulated from the remainder of the tower, such as by including insulation 20 as shown in FIG. 2.

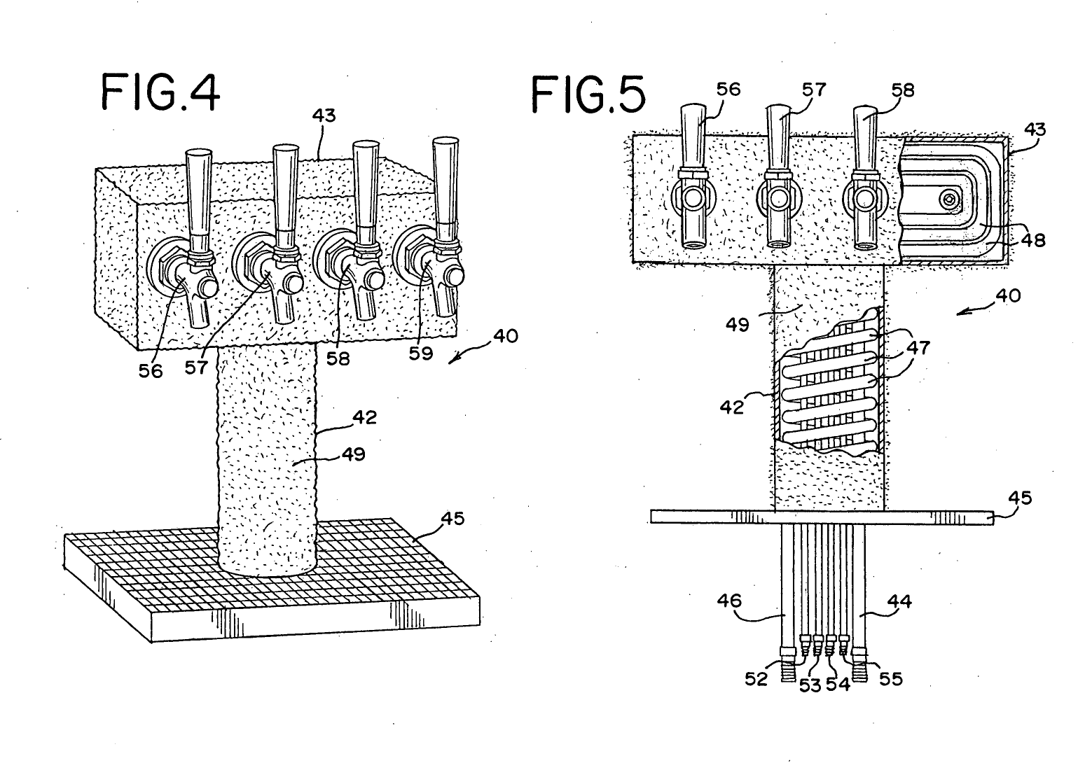

Another embodiment of an iced beverage dispensing tower 40 is shown in FIGS. 4 and 5. The tower 40 is often referred to as a T-tower. While it may include any number of taps, the embodiment shown includes four beverage dispensing taps 56, 57, 58 and 59. Again, the tower 40 is shown as part of a beverage serving system. A drain surface 45 is provided on the countertop around the base of the tower and under the dispensing taps. Four beverage supply lines 52, 53, 54 and 55 are each attached to one of the taps. The housing has a base 42 and a cross arm 43. The base 42 has a cylindrical shape and the cross arm 43 has a rectangular solid shape. The confined cooling channel, like the tower 10, is provided by coolant tubing. The coolant tubing includes an inlet 44 and an outlet 46, and a plurality of tubing turns 47 inside the cylindrical base 42. In addition, the tubing includes coils 48 in thermal contact with the inside surface of the cross arm 43. In this fashion, both the base and cross arm are iced over by a layer of frost 49.

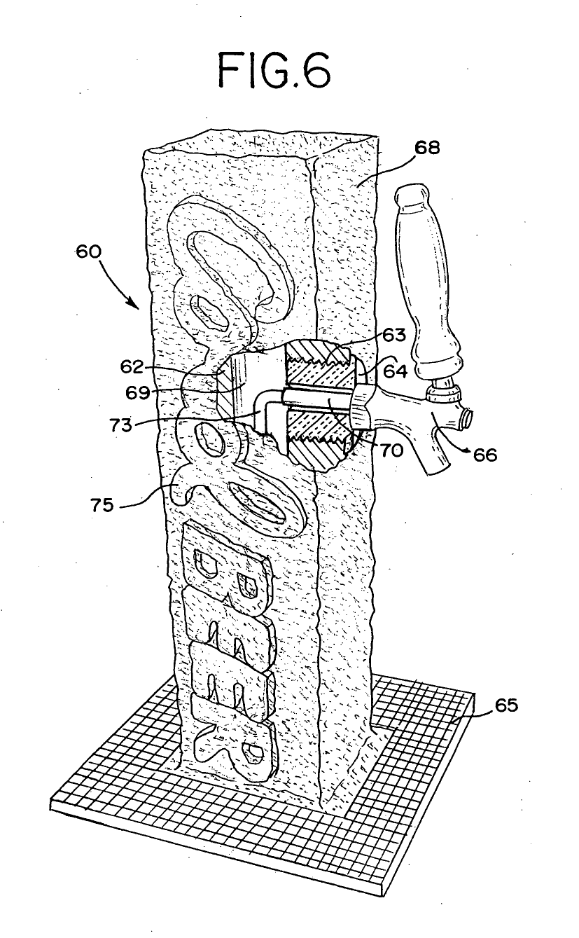

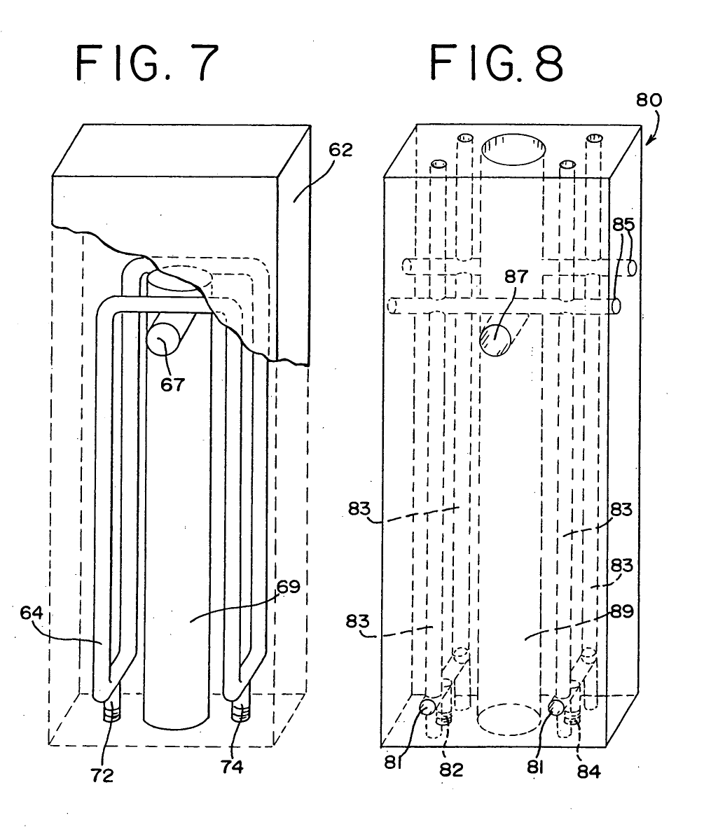

A third embodiment of an iced beverage dispensing tower 60 is shown in FIGS. 6 and 7. Again, the tower 60 is shown as part of a beverage serving system. A drain surface 65 is provided on the countertop around the base of the tower and under the dispensing tap 66.

FIG. 6 shows a casting 62 used to make the tower 60. The casting is preferably metal, and includes tubing 64 encased in the casting. Thus, in this embodiment the confined cooling channel comprises a plurality of channels formed in a wall section of the housing. The tubing 64 has an inlet 72 and an outlet 74 attached to it before it is encased in the casting. The inlet and outlet may include fittings that are encased in the metal used for the casting but have exposed threads to which glycol coolant lines can be attached. The tubing 64 preferably includes a plurality of loops inside the casting. In the embodiment shown, the tubing includes two Tee connections and two U-shaped loops. Of course other tubing configurations may be used. For example, the tubing used for the coolant lines in tower 10, with its helical coil turns 28, could be used instead.

The casting 62 also includes a hollow central section 69 and channel 67. These may be formed by a sand core when the casting 62 is formed, and then removed to leave the hollow center section and channel.

The casting is constructed into the tower 60 as shown in FIG. 6. The beverage supply line 73 is placed inside the hollow center area 69 and connected to a beverage dispensing tap 66. The casting 62 thus forms the housing of the tower. The tap 66 is connected to the beverage supply line by a shank 70 which passes through a wall of the housing, and an insulator 63 insulates the shank from the housing wall. The channel 67 may be threaded so that the insulator 63 can screw into the casting to surround the beverage supply line 73 and the shank 70 of the tap 66. Alternatively, the insulator may be formed so that it can be snap inserted into place. The insulator preferably includes a beveled flange 64 to provide a smooth transition between the insulator and the housing. When a cooling fluid such as glycol at 26-27° F. passes through the tubing 64, the casting 62 is cooled to a temperature below 32° F. so that a layer of frost 68 forms on the outside of the casting 62. Any surface ornamentation included on the casting, such as lettering 75 shown, also frosts over, giving a very appealing look to the beverage dispensing tower 70.

Instead of using a casting 62 to form the housing of the tower 60, a block of metal 80 may be drilled, as shown in FIG. 8. Long channels 83 are drilled lengthwise near the corners of the block. Cross channels 81 are drilled from the front to the back in the lower section of the block so as to intersect the long channels 83. Cross channels 85 are drilled through the top section of the block from side to side, again intersecting the long channels 83. A large central section 89 is provided in the center of the block, and a short channel 87 is drilled in from the front face so as to intersect the large central channel 89. Inlet channel 82 and outlet channel 84 are also drilled into the block so as to intersect cross channels 81 as shown. The ends of each of the long channels 83 and cross channels 81 and 85 are then capped. When a cooling fluid is introduced into inlet 82, it will flow through the cross channel 81 on the left side of block 80, up through the two long channels 83 also on the left side, then cross over to the long channels 83 on the right side of the block through cross channels 85. From there the cooling fluid will travel to the cross channel 81 on the right side of the block and out through outlet 84. The top of central section 89 is also capped. The central section 89 and short channel 87 are then used to construct the tower, just as central section 69 and channel 67 of casting 62 are used. With this embodiment, the coolant is inside of a plurality of channels formed in a wall section of the housing.

The housing 12 is preferably made of stainless steel. The housing formed by the casting 62 preferably comprises aluminum. The insulation 22 may be foam in place insulation. While not shown, the center sections of towers 40 and 60 may also include insulation between the walls of the housing and the beverage supply lines. Likewise, an insulating sleeve may surround the shank of the dispensing tap where it exits through the wall of housing 12 or cross arm 43. The beverage lines inside the housing are preferably 0.25 inch O.D, 0.022 inch wall thickness, stainless steel tubing. The tubing used to make the coils, including turns 28, inside tower 10 is preferably copper or stainless steel with an O.D. of 0.375 inches and a wall thickness of 0.028 inches. The tubing 64 used to make the cooling channels in the casting 62 is preferably stainless steel with an O.D. of 0.375 inches and a wall thickness of 0.028 inches. Chilled glycol at 26-27° F. is the preferred cooling fluid. When beer is dispensed from the tower, it will preferably be dispensed at 30° F. or higher, the temperature being dependant on the type of beer and the preferences of the establishment owner, because light beer tends to freeze below 29° F., and other beers freeze at temperatures of 26° F. and higher. The preferred embodiments of the invention will have sufficient thermal contact to ice over the housing at temperatures greater than 68° F., such as 75° F. or even 80° F.

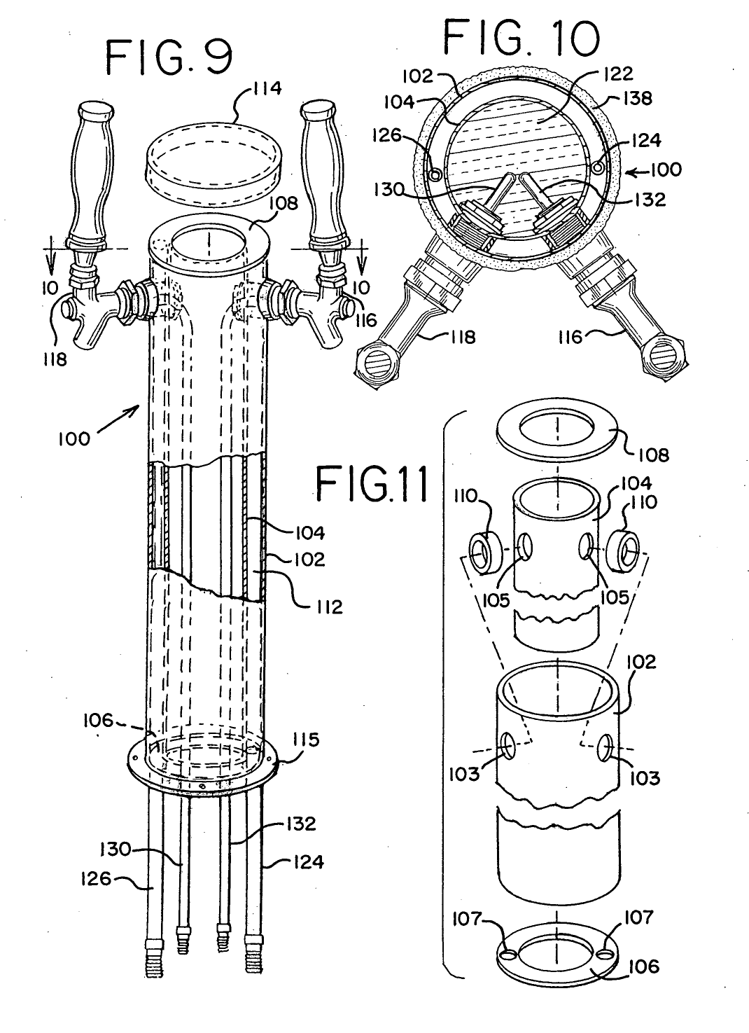

FIGS. 9-11 show another embodiment a cylindrical tower 100 like tower 10 in FIG. 1, but made in a different fashion. In tower 100, the exterior surface is on a housing which has an internal hollow wall 112. The hollow wall exists between two generally concentric pipes of different diameters, the smaller one 104 inside the larger one 102. The exterior surface is thus provided by the outer surface of the larger diameter pipe, and gets iced over with frost 138 (shown in FIG. 10) when the hollow area 112 is flooded with a coolant.

The coolant flow path includes a coolant inlet formed at the top of inlet tube 124 near the bottom of the internal hollow wall 112. An outlet tube 126 extends inside the hollow wall 112 almost to the top. In this regard, coolant entering the inlet will flood the space inside the internal wall 112. The coolant flow path is confined by the space between the pipes 102 and 104. The beverage supply lines 132 and 134 are not in direct contact with this coolant flow path. The supply lines may include coils like coils 34 of tower 10.

Other aspects of the tower 100, such as the two beverage dispensing taps 116 and 118, flange 115 and cap 114 are like those same parts of tower 10. Insulation 122 may be foamed in place inside pipe 104 after the tower is assembled.

The tower 100 is made by first welding collars 110 around holes 105 on the outside of pipe 104. Holes 105 allow the shanks of taps 116 and 118 to pass through the hollow wall 112 and connect to the supply lines 130 and 132. Similar holes 103 in pipe 102 are then sealed against collars 110. Rings 106 and 108 are then welded over the ends of the pipes 102 and 104. Ring 106 includes two holes 107 through which the inlet and outlet tubes 124 and 126 pass. The holes 107 are sealed around these tubes. The flange 115 may be silver soldered to the outer pipe 102 and buffed out to make a very hard to see seam.

Tower 140 shown in FIG. 12 represents a type of tower where the housing is made of two structures, a main housing structure on which the beverage dispensing taps 156 and 157 are mounted, and a secondary structure which provides the exterior surface 148 which gets frosted over in use. The secondary structure at least partially surrounds the main housing structure and provides the visible exterior surface. The main housing structure may be a conventional draught arm tower. The exterior surface comprises the exposed surface of tubing 142 wound in a helix around the cylindrical base of the draught arm tower. A flange 145 is provided to mount the tower 140 to a countertop.

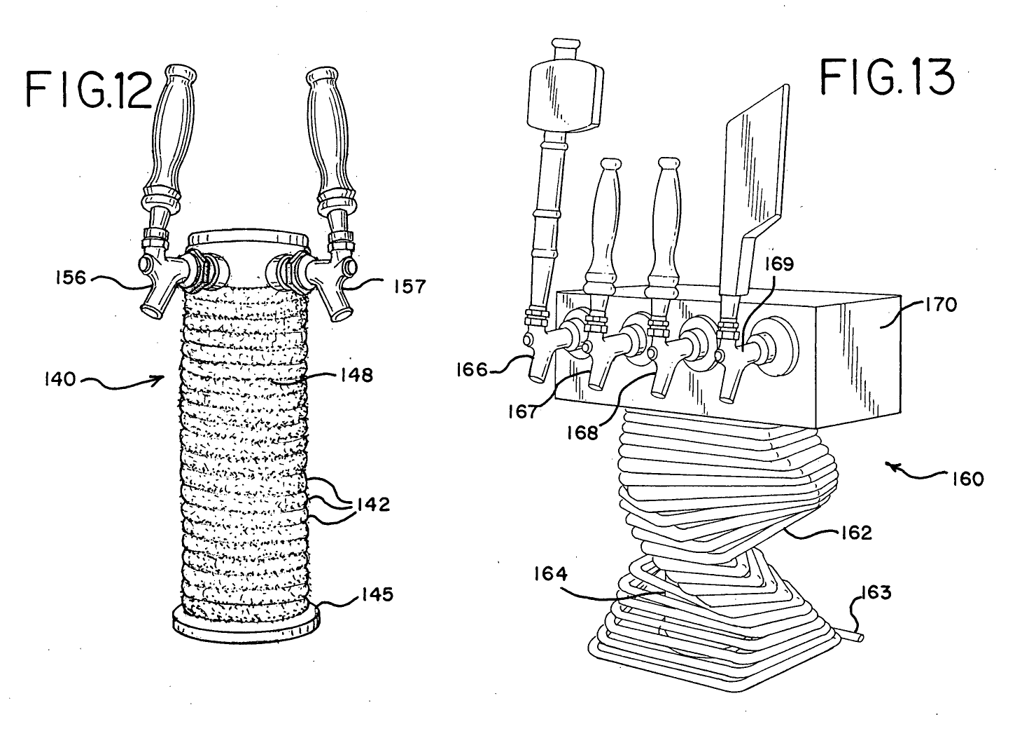

Tower 160 shown in FIG. 13 represents another tower where the housing is made of two structures. In this case, the main housing is a conventional T-tower with a cylindrical base 164 and a cross arm 170 on which the dispensing taps 166, 167, 168 and 169 are mounted. The secondary structure comprises tubing 162 bent into a decorative shape. Coolant flows into the tubing through inlet 163 and through an outlet (not shown). Circulation of the coolant causes the tubing 162 to frost over, thus creating a pleasing frosted over exterior surface to the tower 160.

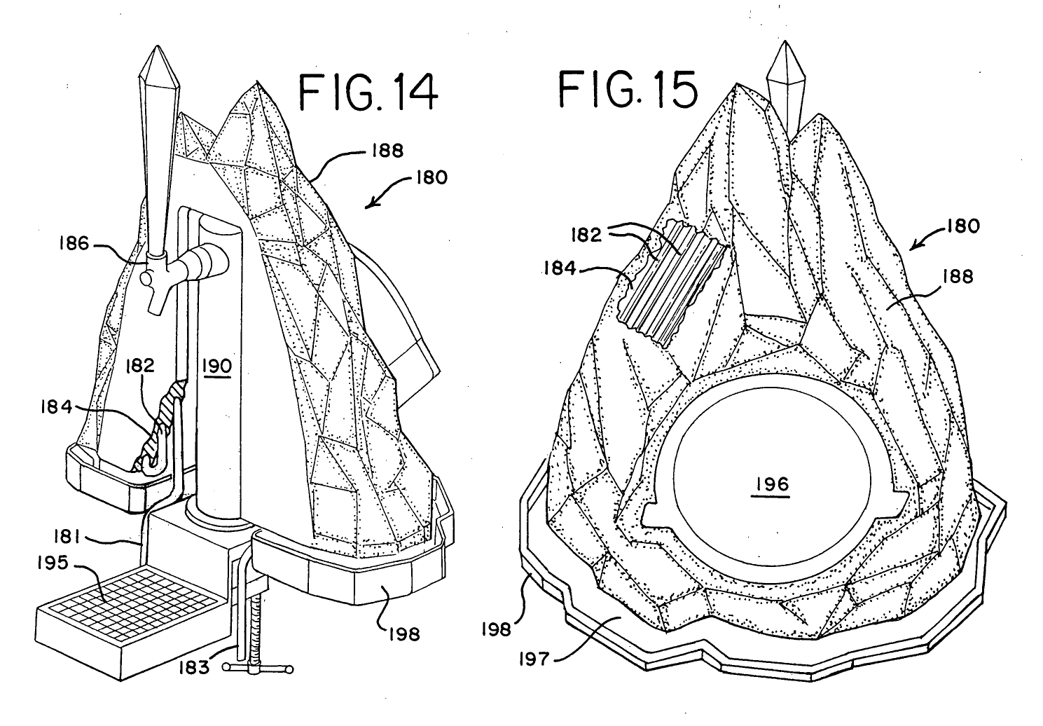

Another tower 180 where the housing is made of two structures in shown in FIGS. 14 and 15. The particular “mountain” shape of this tower was suggested by another party, and forms no part of the present invention. The “mountain” may include a display panel 196 on which a beverage brand may be affixed. The display panel may or may not get frosted over during use. However, the way, discussed below, that the “mountain” shape of the tower is cooled so that it is frosted over was the invention of at least one of the presently named inventors.

In this embodiment, the tower 180 has a main housing structure 190 in the form of a draught arm with a dispensing tap 186. The secondary housing, by which the exterior surface is provided, is a shell 188 that has tubing 182 embedded in it. The tubing 182 provides the coolant flow path that cools the exterior surface of the shell 188. Inlet line 181 and outlet line 183 allow coolant fluid, such as glycol, to be circulated through the tubing 182.

The shell may be formed by first bending the tubing 182 into a shape that will cool the portions of the shell that are to be frosted over. The tubing 182 is then embedded in aluminum by being cast with a sand core in a mold. The sand core is removed to leave the shell with a wall 184 in which the tubing 182 is embedded. The hollow area inside the center of the shell accommodates the main housing 190. A condensate drain channel 197 may be provided by a base 198 which is placed beneath the tower 180. The dispensing tap 186 may be located over a drip tray 195.

By using the present invention, other shapes of iced over beverage dispensing towers than the cobra tower can be made. These beverage dispensing towers provide a very pleasing aesthetic appearance when iced over, conveying the idea that beverages dispensed there from are ice cold.

It will be appreciated that the preferred embodiments described above are subject to modification without departing from the invention. For example, the confined cooling channel could carry an evaporating refrigerant, in which case the cooling channel would comprise an evaporator component of a compression refrigeration system. While one, two and four tap embodiments of the invention have been shown, other towers may have other numbers of taps. While the tower 40 is shown completely iced over, the tower 10 has a cap that is not iced over. The tower 40 could be configured so that only the base, or only the cross arm, gets iced over. In other embodiments, other sections of the housing may be insulated or otherwise designed so as to not be iced over. By the term “majority of the housing” it is meant that at least half of the surface area of the housing that is visible to the public when the tower is installed is iced over. In the case of the towers 10 and 40 having a cylindrical base, a flooded housing could be used, although this is more costly than the preferred embodiments of the invention. While beer dispensing taps are shown in the drawings, the term “beverage dispensing tap” includes valves, faucets, spigots, spouts and other types of controllable flow openings through which a beverage can be dispensed. Therefore it should be understood that the invention is to be defined by the following claims rather than the preferred embodiments described above.

We claim:

1. A beverage dispersing tower comprising:
a) a visible exterior surface;
b) at least one beverage dispensing tap and a beverage supply line connected thereto;
c) a coolant flow path in sufficient thermal contact with the exterior surface so that as coolant flows through the flow path, at least part of the exterior surface can be cooled to a temperature below 32° F. when the dispensing tower is in contact with air having and ambient temperature of 68° F., the coolant flow path not being in direct contact with the beverage supply line.

2. The beverage dispensing tower of claim 1 wherein the exterior surface has a cylindrical shape.

3. The beverage dispensing tower of claim 1 wherein the at least one beverage dispensing tap comprises a plurality of beverage dispensing taps.

4. The beverage dispensing tower of claim 1 wherein said exterior surface is on a housing on which the beverage dispensing tap is also mounted.

5. The beverage dispensing tower of claim 4 wherein the housing has a base and a cross arm.

6. The beverage dispensing tower of claim 1 wherein the tower includes a main housing structure on which the beverage dispensing tap is mounted and a secondary structure which comprises said exterior surface.

7. The beverage dispensing tower of claim 6 wherein the secondary structure comprises tubing bent into a decorative shape.

8. The beverage dispensing tower of claim 1 further comprising an insulating solid between the confined cooling channel and the beverage supply line.

9. The beverage dispensing tower of claim 8 wherein the insulating solid comprises insulating foam.

10. The beverage dispensing tower of claim 1 wherein the exterior surface comprises exposed surface of tubing wound in a helix around a cylindrical housing.

11. The beverage dispensing tower of claim 1 wherein the exterior surface comprises a cap and the cap is insulated so as to not frost over when the remainder of the exterior ices over.

12. The beverage dispensing tower of claim 1 wherein the beverage supply line supplies beer to the dispensing tap.

13. The beverage dispensing tower of claim 12 wherein the beverage supply line comprises at least one coil inside the tower.

14. The beverage dispensing tower of claim 1 wherein the exterior surface is provided by a shell that has tubing embedded in the shell, the tubing providing the coolant flow path.

15. The beverage dispensing tower of claim 1 wherein the coolant flow path carries a liquid coolant.

16. The beverage dispensing tower of claim 15 wherein the liquid coolant comprises glycol.

17. The beverage dispensing tower of claim 1 wherein the coolant flow path comprises an evaporator component of a compression refrigeration system.

18. The beverage dispensing tower of claim 1 wherein the coolant flow path comprises tubing.

19. The beverage dispensing tower of claim 1 wherein the coolant flow path comprises a plurality of channels formed in a wall section of a housing that comprises said exterior surface.

20. The beverage dispensing tower of claim 1 wherein the exterior surface is on a housing which has an internal hollow wall, and the coolant flow path comprises a coolant inlet near the bottom of said internal hollow wall, an outlet tube inside said hollow wall extending toward the top of said internal wall and flooded space within the hollow wall.

21. The beverage dispensing tower of claim 20 wherein the hollow wall exists between two generally concentric pipes of different diameters, one inside the other, and the exterior surface comprises the outer surface of the larger diameter pipe.

22. The beverage dispensing tower of claim 1 wherein the tap is connected to the beverage supply line by a shank which passes through a wall of a housing on which the exterior surface is formed, and an insulator insulates the shank from the housing wall.

23. An iced-over beverage dispensing tower comprising:
a) a housing comprising a cylindrical base;
b) at least one beverage dispensing tap mounted on the housing and a beverage supply line connected thereto inside the housing; and
c) a coolant in sufficient thermal contact with the housing to cool a majority of the housing to a temperature below 32° F. when the housing is in air with an ambient temperature of 68° F.

24. The iced-over beverage dispensing tower of claim 23 wherein the housing further comprises a cross arm supported on the cylindrical base, wherein both the base and cross arm are iced over.

25. The iced-over beverage dispensing tower of claim 23 wherein the coolant is inside of a plurality of channels formed in a wall section of the housing.

26. A beverage serving system comprising:
a) a countertop having a drain surface; and
b) a beverage dispensing tower upstanding from the countertop comprising:
i) a housing having an exterior visible surface;
ii) at least one beverage dispensing tap mounted on the housing and a beverage supply line connected thereto inside the housing, the dispensing tap being located above the drain surface; and
iii) at least one confined cooling channel inside the housing in sufficient thermal contact with the housing so that when a coolant flows through the channel, at least a majority of the exterior surface of the housing can be cooled to a temperature below 32° F. when the exterior surface is in contact with air having an ambient temperature of 68° F.

27. The beverage serving system of claim 26 wherein the housing comprises a single structure.

28. The beverage serving system of claim 26 wherein the housing comprises a main structure housing the beverage supply line and to which the dispensing tap is attached, and a secondary structure at least partially surrounding the main structure and providing said visible exterior surface.

29. A beverage dispensing system comprising:
a) a beverage dispensing tower comprising a housing and having at least one beverage dispensing tap mounted on the housing;
b) a beverage supply source connected to the beverage dispensing tap by a beverage line; and
c) at least one confined cooling channel inside the housing in sufficient thermal contact with the housing so that when a coolant flows through the channel, at least a majority of the housing can be cooled to a temperature below 32° F. when the housing is in contact with air having an ambient temperature of 68° F.

30. A beverage dispensing tower comprising:
a) a housing;
b) at least one beverage dispensing tap mounted on the housing and a beverage supply line connected thereto inside the housing; and
c) at least one confined cooling channel inside the housing in sufficient thermal contact with the housing so that when a coolant flows through the channel, at least a majority of the housing can be cooled to a temperature below 32° F. when the housing is in contact with air having an ambient temperature of 68° F.
